(19) United States
(12) Patent Application Publication
(10) Pub. No.: US 2018/0286549 A1
(43) Pub. Date: Oct. 4, 2018

(54) TRANSFORMER

(71) Applicant: TERRA BEE CO., LTD., Uiwang-si, Gyeonggi-do (KR)

(72) Inventor: Han Ho KIM, Suwon-si, Gyeonggi-do (KR)

(73) Assignee: TERRA BEE CO., LTD., Uiwang-si, Gyeonggi-do (KR)

(21) Appl. No.: 15/765,272

(22) PCT Filed: Oct. 26, 2016
(86) PCT No.: PCT/KR2016/012042

§ 371 Date: Apr. 2, 2018

(30) Foreign Application Priority Data
Oct. 28, 2015 (KR) 10-2015-0149873

(51) Int. Cl. H01F 1/34; H01F 27/26; H01F 27/32

(52) U.S. Cl. CPC H01F 1/34; H01F 27/32; H01F 27/26

(57) ABSTRACT

A transformer includes a lower magnetic core having a lower column upwardly formed at a center thereof; an upper magnetic core having an upper column downwardly formed at a center thereof, the lower upper and magnetic cores being symmetrically coupled so that the lower and upper columns are engaged with each other; a double-sided printed circuit board being fitted through an opening formed on a center thereof around a middle of the columns and having primary coils patterned on both surfaces thereof; a lower secondary coil molded product being fitted through an opening formed on a center thereof around a lower portion of the columns and including a secondary coil embedded therein; and an upper secondary coil molded product being fitted through an opening formed at a center thereof around an upper portion of the columns and including a secondary coil embedded therein.

### TECHNICAL FIELD

The present invention relates to a transformer.

### BACKGROUND ART

Generally, a transformer, which is a device for raising or lowering an AC (alternating current) voltage by using an electromagnetic induction, includes a primary coil, a secondary coil, and a magnetic core.

When a planar secondary coil is placed adjacent to a planar primary coil constituting a transformer, it is necessary to position the secondary coil firmly within a molded product using an insert injection or the like so that the transformer operates stably.

Related Patent Document: Korean Registered Patent No. 10-0366241, registered on Dec. 31, 2002, entitled “TRANSFORMER HAVING THIN PLATE OF PLANE TYPE.”

### Technical Problem

The present invention is designed to solve the above described needs, and therefore, an object of the present invention is to provide a transformer in which a double-sided printed circuit board has primary coils patterned on both sides thereof, a lower secondary coil molded product having a lower secondary coil embedded therein by insert-injection is placed adjacent to the bottom surface of the double-sided printed circuit board and an upper secondary coil molded product having an upper secondary coil embedded therein by insert-injection is placed adjacent to the upper surface of the double-sided printed circuit board.

### Technical Solution

The object as set forth above is achieved as follows.

In accordance with an aspect of the present invention, there is provided a transformer.

The transformer includes:

a lower magnetic core 10 being in a form of a rectangular plate with walls upwardly formed at its left and right ends and having a lower column 12 upwardly formed at a center of the plate, wherein the lower magnetic core is provided with a lower seating portion 14 in which front and back-side plate surfaces with respect to the lower column 12 are more recessed than left and right-side plate surfaces with respect to the lower column 12;

an upper magnetic core 20 being in a form of a rectangular plate with walls downwardly formed at its left and right ends and having an upper column 22 downwardly formed at a center of the plate, wherein the upper magnetic core is provided with an upper seating portion 24 in which front and back-side plate surfaces with respect to the upper column 22 are more recessed than left and right-side plate surfaces with respect to the upper column 22, and wherein the upper magnetic core 20 is symmetrically coupled with the lower magnetic core 10 such that the lower and upper columns are engaged with each other;

a double-sided printed circuit board 30 configured to be fitted around a middle of an unity, in which the lower column 12 and the upper column 22 are engaged with each other, through an opening formed on a center of the double-sided printed circuit board, wherein the double-sided printed circuit board has primary coils patterned on both surfaces thereof;

a lower secondary coil molded product 40 configured to be fitted around a lower portion of the unity, in which the lower column 12 and the upper column 22 are engaged with each other, through an opening formed on a center of the lower coil molded product, wherein the lower secondary coil molded product includes a lower secondary coil 42 embedded therein; and

an upper secondary coil molded product 50 configured to be fitted around an upper portion of the unity, in which the lower column 12 and the upper column 22 are engaged with each other, through an opening formed at a center of the upper secondary coil molded product, wherein the upper secondary coil molded product includes an upper secondary coil 52 embedded therein.

In the aspect:

The lower magnetic core 10 and the upper magnetic core 20 are made of a magnetic material.

The magnetic material is ferrite.

The lower secondary coil 42 and the upper secondary coil 52 are made of copper.

The lower secondary coil 42 is patterned by press-punching in the shape thereof and the whole surface of the patterned lower secondary coil is coated with an insulating material, and wherein the lower secondary coil 42 is embedded in the lower secondary coil molded product 40 in such a manner that an inner end portion of the shape of the lower secondary coil 42 is bent outward from the shape while being spaced from coil portions to be jumped within the shape; the shape of the lower secondary coil is fixed by a primary insert injection; and a durability thereof is enhanced by a secondary insert injection.

The upper secondary coil 52 is patterned by press-punching in the shape thereof and a whole surface of the patterned upper secondary coil is coated with an insulating material, and wherein the upper secondary coil 52 is embedded in the upper secondary coil molded product 50 in such a manner that an inner end portion of the shape of the upper secondary coil 52 is bent outward from the shape while being spaced from coil portions to be jumped within the shape; a shape of the upper secondary coil is fixed by a primary insert injection; and a durability thereof is enhanced by a secondary insert injection.

### Advantageous Effects

In accordance with the present invention, the double-sided printed circuit board 30 has the primary coils patterned on both surfaces thereof, the lower secondary coil molded product 40 having the lower secondary coil 42 fixed therein by insert-injection is placed adjacent to the bottom surface of the double-sided printed circuit board 30, and the upper secondary coil molded product 50 having the upper secondary coil 52 fixed therein by insert-injection is placed adjacent to the upper surface of the double-sided printed circuit board 30. Accordingly, the lower secondary coil 42 is firmly fixed in the lower secondary coil molded product 40 and the upper secondary coil 52 is firmly fixed in the upper secondary coil molded product 50, thereby providing an advantage that the transformer operates stably.

### DESCRIPTION OF DRAWINGS

FIG. 1 is a perspective view of a transformer in accordance with the present invention.

FIG. 2 is an exploded perspective view of the transformer shown in FIG. 1.

FIGS. 3A to 3D are views showing steps of manufacturing an upper secondary coil molded product shown in FIG. 1.

### BEST MODE

Hereinafter, embodiments of the present invention will be described in detail with reference to the drawings.

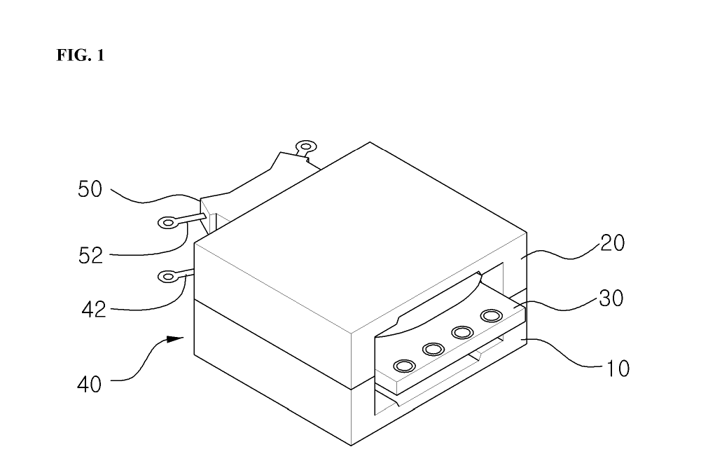

FIG. 1 is a perspective view of a transformer in accordance with the present invention. The transformer includes a lower magnetic core 10, an upper magnetic core 20, a double-sided printed circuit board 30, a lower secondary coil molded product 40, a lower secondary coil 42, an upper secondary coil molded product 50, and an upper secondary coil 52.

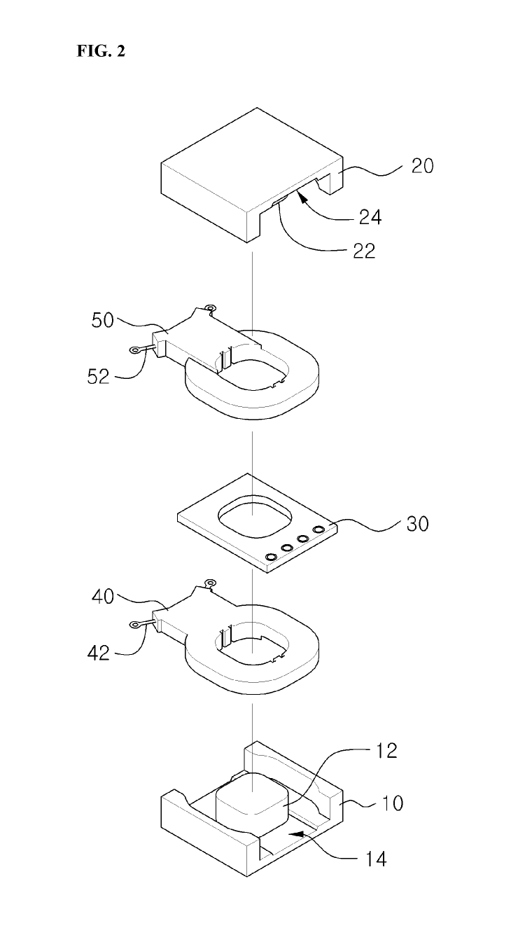

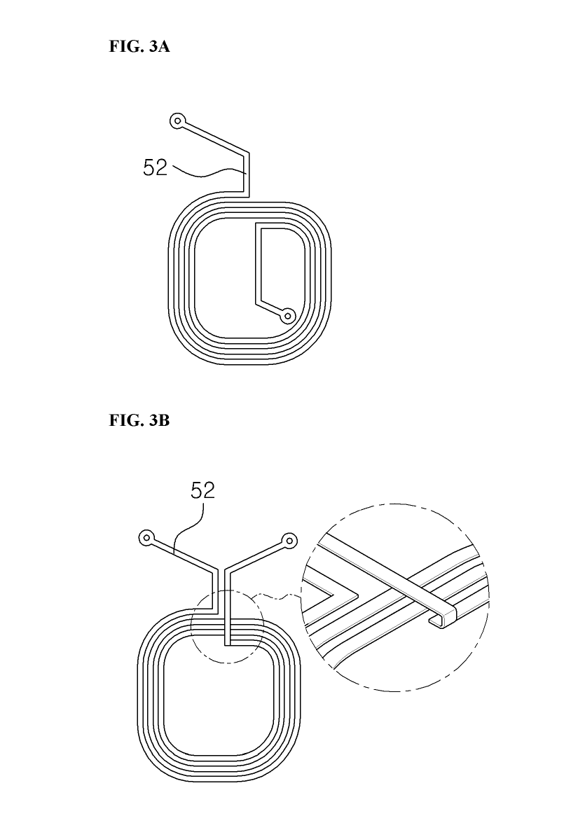

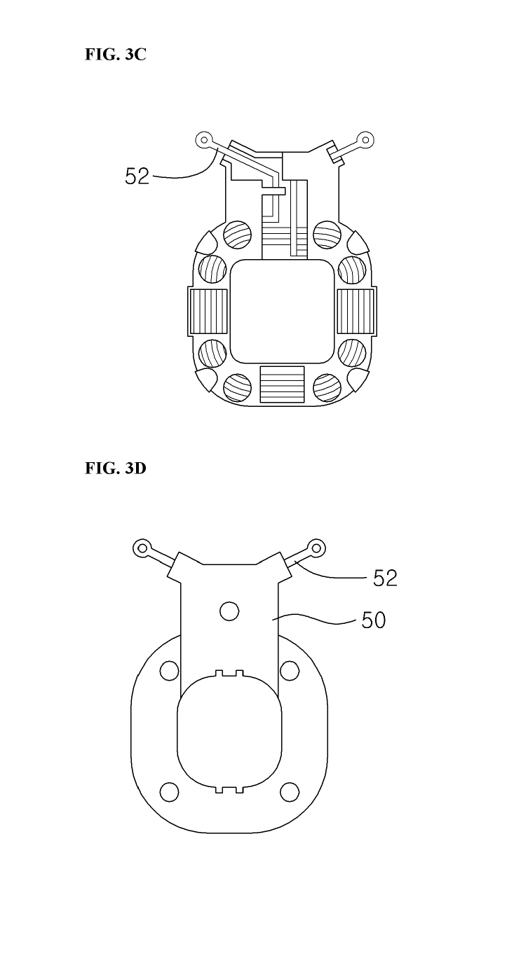

The present invention as set forth above will now be described in detail with reference to FIGS. 2 and 3A to 3D.

FIG. 2 is an exploded perspective view of the transformer shown in FIG. 1. The transformer includes a lower magnetic core 10, a lower column 12, a lower seating portion 14, a upper magnetic core 20, an upper column 22, an upper seating portion 24, a double-sided printed circuit board 30, a lower secondary coil molded product 40, a lower secondary coil 42, an upper secondary coil molded product 50, and an upper secondary coil 52.

FIGS. 3A to 3D are views illustrating steps of manufacturing the upper secondary coil molded product 50 shown in FIG. 1. The manufacturing process of the lower secondary coil molded product 40 is the same or approximately the same as the manufacturing process of the upper secondary coil molded product 50, and therefore, the manufacturing process of the lower secondary coil molded product 40 is not shown in a separate drawing.

Referring to FIGS. 1, 2, and 3A to 3D, the lower magnetic core 10 is in the form of a rectangular plate having inwardly rounded walls upwardly formed at its left and right ends and the lower column 12 is upwardly formed at the center of the lower magnetic core 10. The lower magnetic core 10 is provided with the lower seating portion 14 in which the front and back-side plate surfaces with respect to the lower column 12 are more recessed than the left and right-side plate surfaces with respect to the lower column 12. A flat portion that protrudes downwardly at the rear of the lower secondary coil molded product 40 is seated on one of the front and back-side plate surfaces, e.g., the back-side plate surface, in the lower seating portion 14.

The upper magnetic core 20 is in the form of a rectangular plate having inwardly rounded walls downwardly formed at its left and right ends and the upper column 22 is downwardly formed at the center of the upper magnetic core 20. The upper magnetic core 20 includes the upper seating portion 24 in which the front and back-side plate surfaces with respect to the upper column 22 are more recessed than the left and right-side plate surfaces with respect to the upper column 22. The upper magnetic core 20 is coupled to be symmetrical to the lower magnetic core 10. A flat portion that protrudes upwardly at the rear of the upper secondary coil molded product 50 is seated on the back-side plate surface in the upper seating portion 24.

The lower magnetic core 10 and the upper magnetic core 20 are made of a magnetic material, e.g., ferrite.

The double-sided printed circuit board 30 is configured to be fitted around the middle portion of a unity, in which the lower column 12 and the upper column 22 are engaged with each other, through an opening formed at the center of the double-sided printed circuit board. The double-sided printed circuit board 30 has primary coils patterned on both surfaces thereof.

The lower secondary coil molded product 40 is configured to be fitted around the lower portion of the unity, in which the lower column 12 and the upper column 22 are engaged with each other, through an opening formed at the center of the lower secondary coil molded product. The lower secondary coil molded product 40 has the lower secondary coil 42 embedded therein. The lower secondary coil 42 is made of copper.

The lower secondary coil 42 as described above is patterned by press-punching in the shape shown in FIG. 3A and the whole surface of the patterned lower secondary coil 42 is coated with an insulating material. The lower secondary coil 42 is embedded in the lower secondary coil molded product 40 in such a manner that an inner end portion of the shape of the lower secondary coil 42 is bent outward from the shape while being spaced from coil portions to be jumped within the shape, as shown in FIG. 3B; the shape of the lower secondary coil 42 is fixed by a primary insert injection to prevent short-circuiting between coil portions; and the durability thereof is enhanced by a secondary insert injection, as shown in FIG. 3C.

The upper secondary coil molded product 50 is configured to be fitted around the upper portion of the unity, in which the lower column 12 and the upper column 22 are engaged with each other, through an opening formed at the center of the upper secondary molded product. The upper secondary coil molded product 50 has the upper secondary coil 52 embedded therein. The upper secondary coil 52 is made of copper.

The upper secondary coil 52 as described above is patterned by press-punching in the shape shown in FIG. 3A and the whole surface of the patterned upper secondary coil is coated with an insulating material. The upper secondary coil 52 is embedded in the upper secondary coil molded product 50 in such a manner that an inner end portion of the shape of the upper secondary coil 52 is bent outward from the shape while being spaced from coil portions to be jumped within the shape, as shown in FIG. 3A; the shape of the upper secondary coil 52 is fixed by a primary insert injection to prevent short-circuiting between the coil portions; and the durability thereof is enhanced by a secondary insert injection, shown in FIG. 3C.

Meanwhile, it may be preferred that the lower secondary coil molded product 40, the double-sided printed circuit board 30, and the upper secondary coil molded product 50 are insert-injected in a form laminated in that order so that they may be conveniently handled as a united molded product.

As such, in the present invention, the primary coils are formed on both surfaces of the double-sided printed circuit board 30, and the lower secondary coil molded product 40 having the lower secondary coil 42 fixed therein by insert-injection is placed adjacent to the bottom surface of the double-sided printed circuit board 30 and the upper secondary coil molded product 50 having the upper secondary coil 52 fixed therein by insert-injection is placed adjacent to the upper surface of the double-sided printed circuit board 30. Therefore, the lower secondary coil 42 may be firmly fixed in the lower secondary coil molded product 40 and the upper secondary coil 52 may be firmly fixed in the upper secondary coil molded product 50, which provides an advantage that the transformer operates stably.

Although the technical idea of the present invention is described in conjunction with the accompanying drawings, it is merely illustrated by way of a preferred embodiment of the present invention and not limited to the description of the present invention. In addition, it will be apparent to those skilled in the art that various changes and modifications may be readily made without departing from the scope of the technical idea of the present invention.

1. A transformer comprising:
a lower magnetic core 10 being in a form of a rectangular plate with walls upwardly formed at its left and right ends and having a lower column 12 upwardly formed at a center of the plate, wherein the lower magnetic core is provided with a lower seating portion 14 in which front and back-side plate surfaces with respect to the lower column 12 are more recessed than left and right-side plate surfaces with respect to the lower column 12;
an upper magnetic core 20 being in a form of a rectangular plate with walls downwardly formed at its left and right ends and having an upper column 22 downwardly formed at a center of the plate, wherein the upper magnetic core is provided with an upper seating portion 24 in which front and back-side plate surfaces with respect to the upper column 22 are more recessed than left and right-side plate surfaces with respect to the upper column 22 and wherein the upper magnetic core 20 is symmetrically coupled with the lower magnetic core 10 such that the lower and upper columns are engaged with each other;
a double-sided printed circuit board 30 configured to be fitted around a middle of an unity, in which the lower column 12 and the upper column 22 are engaged with each other, through an opening formed on a center of the double-sided printed circuit board, wherein the double-sided printed circuit board has primary coils patterned on both surfaces thereof;
a lower secondary coil molded product 40 configured to be fitted around a lower portion of the unity, in which the lower column 12 and the upper column 22 are engaged with each other, through an opening formed on a center of the lower coil molded product, wherein the lower secondary coil molded product includes a lower secondary coil 42 embedded therein; and
an upper secondary coil molded product 50 configured to be fitted around an upper portion of the unity, in which the lower column 12 and the upper column 22 are engaged with each other, through an opening formed at a center of the upper secondary coil molded product, wherein the upper secondary coil molded product includes an upper secondary coil 52 embedded therein.

2. The transformer according to claim 1, wherein the lower magnetic core 10 and the upper magnetic core 20 are made of a magnetic material.

3. The transformer according to claim 2, wherein the magnetic material is ferrite.

4. The transformer according to claim 1, wherein the lower secondary coil 42 and the upper secondary coil 52 are made of copper.

5. The transformer according to claim 1, wherein the lower secondary coil 42 is patterned by press-punching in the shape thereof and the whole surface of the patterned lower secondary coil is coated with an insulating material, and wherein the lower secondary coil 42 is embedded in the lower secondary coil molded product 40 in such a manner that an inner end portion of the shape of the lower secondary coil 42 is bent outward from the shape while being spaced from coil portions to be jumped within the shape; the shape of the lower secondary coil is fixed by a primary insert injection; and a durability thereof is enhanced by a secondary insert injection.

6. The transformer according to claim 1, wherein the upper secondary coil 52 is patterned by press-punching in the shape thereof and a whole surface of the patterned upper secondary coil is coated with an insulating material, and wherein the upper secondary coil 52 is embedded in the upper secondary coil molded product 50 in such a manner that an inner end portion of the shape of the upper secondary coil 52 is bent outward from the shape while being spaced from coil portions to be jumped within the shape; the shape of the upper secondary coil is fixed by a primary insert injection; and a durability thereof is enhanced by a secondary insert injection.
